(19) United States
(12) Patent Application Publication
(10) Pub. No.: US 2024/0318749 A1
(43) Pub. Date: Sep. 26, 2024

(54) PLASTIC PIPE AND DEVICE FOR THE CONTINUOUS PRODUCTION OF A PIPE BASE BODY FOR A PLASTIC PIPE OF THIS TYPE

(71) Applicant: Ralph Peter Hegler, Bad Kissingen (DE)

(72) Inventor: Ralph Peter Hegler, Bad Kissingen (DE)

(21) Appl. No.: 18/612,021

(22) Filed: Mar. 21, 2024

(30) Foreign Application Priority Data
Mar. 21, 2023 (EP) 23163153.2

(51) Int. Cl. F16L 9/19; B29C 48/11; B29C 48/335; B29C 48/88; B29L 23/00

(52) U.S. Cl. CPC F16L 9/19; B29C 48/11; B29C 48/335; B29C 48/913; B29L 2023/22

(57) ABSTRACT

A plastic pipe is formed with elevations oriented to be perpendicular to a pipe longitudinal axis on a pipe outer side, with a pipe inner side on which at least one guide element oriented to be parallel to the pipe longitudinal axis is integrally formed, and with a separating element held on the at least one guide element.

### CROSS-REFERENCES TO RELATED APPLICATIONS

This application claims the priority of European Patent Application, Serial No. EP 23 163 153.2, filed Mar. 21, 2023, the content of which is incorporated herein by reference in its entirety as if fully set forth herein.

### FIELD OF THE INVENTION

The invention relates to a plastic pipe and a device for the continuous production of a pipe base body for a plastic pipe of this type.

### BACKGROUND OF THE INVENTION

Pipes with multiple internal chambers, also known as multiple channels, are used for water treatment in wastewater technology or as cable protection pipes. For example, a pipe bundle with multiple interconnected inner pipes is drawn into cable protection pipes. The production and, in particular, the installation of cable protection pipes is complex. The production of plastic pipes having an internal partition wall has limitations with regard to the freedom of design of the plastic pipe. Separate fastening means must be attached to the inside of the pipe for the arrangement and fastening of the partition wall. Production must be carried out in several steps and by means of additional manual labor.

### SUMMARY OF THE INVENTION

It is an object of the invention to simplify the production of a plastic pipe with multiple channels and with a corrugated or ribbed outer side.

This object is achieved by a plastic pipe comprising elevations oriented to be perpendicular to a pipe longitudinal axis on an outer side of the pipe, a pipe inner side on which at least one guide element oriented to be parallel to the pipe longitudinal axis is integrally formed, a separating element held on the at least one guide element and by an apparatus for the continuous production of a pipe base body for a plastic pipe comprising half-molds which are provided with annular mold recesses and complement each other in pairs on a molding section to form a mold with a central longitudinal axis and which are arranged in a circuit and in a conveying direction, an injection head of at least one extruder arranged upstream of the molding section, wherein the injection head has an outer nozzle for extruding an outer pipe, an inner nozzle arranged downstream in the conveying direction for extruding an inner pipe, a calibrating mandrel arranged downstream in the conveying direction with an inner supporting pipe extending along the central longitudinal axis, a cooling jacket held by the supporting pipe with an integrated cooling channel, an outer sleeve held on the cooling jacket with at least one molded structure for integrally forming the at least one guide element.

According to the invention, it has been recognized that at least one guide element can be integrally formed on an, in particular smooth, pipe inner side of a plastic pipe. The at least one guide element serves to hold a separating element which divides the pipe interior into multiple channels. The separating element serves as a partition wall to separate the channels in the plastic pipe. The separating element can have lateral openings to enable a connection between the separate channels. The openings can be useful for water treatment and/or water pre-cleaning, for example.

The separating element can be positioned on the at least one guide element in a defined and, in particular, uncomplicated manner. In particular, the separating element is fixed in place in the circumferential direction around the longitudinal axis of the pipe and, in particular, at an exact angle. The separating element can be inserted into the plastic pipe in the axial direction. Production is simplified.

The separating element can be produced by plastic injection molding or in an additive method, in particular by 3D printing. The separating element can also be produced manually.

The at least one guide element is oriented along the pipe longitudinal axis, i.e. axially aligned. The at least one guide element is molded in one piece on the pipe inner side. With the exception of the at least one guide element, the pipe inner side is designed to be cylindrical. The outer side of the plastic pipe has elevations oriented to be perpendicular to the pipe longitudinal axis. The plastic pipe is in particular a composite pipe with a smooth inner pipe and a corrugated outer pipe connected thereto, in particular welded thereto, as is known, for example, from EP 0 563 575 A2. The plastic pipe can also be a finned pipe according to EP 0 531 750 A2. The production of such finned pipes is known from DE 24 50 171 C2.

The plastic pipe, in particular the pipe base body and the separating element, is made of a plastic material, in particular a thermoplastic material.

In particular, the separating element is supported at at least one further support point on the pipe inner side and is held reliably in the plastic pipe, in particular so that it cannot twist relative to the longitudinal axis of the pipe. It is also conceivable to use multiple separating elements, each of which is held on at least one guide element.

A composite pipe in which the plastic pipe is designed as a composite pipe comprising an inner pipe having an inner diameter and an outer pipe which is welded to the inner pipe and has an outer diameter, wherein: dₐ/dᵢ≥1.15, is particularly suitable for water treatment. In particular, the composite pipe has an inner diameter of at least 100 mm. A typical diameter ratio of the composite pipe from the outer diameter to the inner diameter is at least 1.15, in particular at least 1.20 and in particular at least 1.25. Typical diameter manufacturing tolerances in relation to the outer diameter or in relation to the inner diameter are ±0.25% to ±0.5%.

A plastic pipe in which the at least one guide element is designed as a groove or as a web allows a high degree of freedom of design with regard to the at least one guide element. In particular, depending on the channel division to be produced, the at least one guide element can be designed as a groove, i.e. as a radial recess on the inner side of the pipe, or as a web, i.e. as a radially elevated structure on the inner side of the pipe.

A plastic pipe in which the at least one guide element has, in a plane oriented perpendicularly to the pipe longitudinal axis, a contour whose radii are at least 2.0 mm enables reliable and, in particular, error-free production of the at least one guide element. A rounded contour of the at least one guide element avoids production-related imperfections. The rounding radii used depend on the nominal diameter of the plastic pipe and are in particular at least 2.0 mm.

A plastic pipe in which there is exactly one guide element which has a first height relative to the pipe inner side in the radial direction with respect to the pipe longitudinal axis, wherein h₁≥1.0%·dᵢ or h₁′≥1.0%·dᵢ, ensures the reliable and stable arrangement of the separating element with exactly one guide element. A height of the guide element is at least 1.0% of the inner diameter and in particular at least 1.0% of the outer diameter.

A plastic pipe in which a guide gap, in which the separating element is arranged, is formed between two guide elements arranged adjacently in the circumferential direction about the pipe longitudinal axis enables a stable arrangement of the separating element between two guide elements arranged adjacently in the circumferential direction around the pipe longitudinal axis. A guide gap is formed between the guide elements, in which the at least one separating element is arranged and held therein.

A plastic pipe in which there is a plurality of guide elements on which the separating element is held has a plurality of guide elements, in particular arranged opposite one another. Opposite means, in particular, diametrically opposite with respect to the pipe longitudinal axis, i.e. with an angle of rotation of 180° with respect to the pipe longitudinal axis. Opposite in the sense of the claim, however, also means an angle of rotation with respect to the pipe longitudinal axis that is smaller than 180° and, in particular, is at least 90°. The separating element is held in particular on the plurality of guide elements.

A plastic pipe in which a plurality of guide elements are present, each of which has a second height relative to the pipe inner side in the radial direction with respect to the pipe longitudinal axis, wherein h₂≥0.5%·dᵢ, enables reliable fastening of the separating element to a plurality of guide elements. The height of the guide elements required for this is at least 0.5% of the inner diameter and, in particular, at least 0.5% of the outer diameter.

The embodiment of the separating element as a plate in which the separating element is designed as a plate or as an open profile, in particular as a cross profile, is uncomplicated and cost-efficient. In dependence on the application, in particular the number of channels required, the separating element can be designed as an open profile, in particular as a cross profile. The separating element can have a plurality of webs in a plane perpendicular to the pipe longitudinal axis, which can be arranged in particular such that channels of different sizes are formed in the pipe. The separating element allows a great degree of freedom in the design of the internal channels.

In the plastic pipe in which the separating element has an end face contour corresponding to the at least one guide element, the separating element is arranged in a particularly stable manner. With an end face contour corresponding to at least one guide element, the separating element is arranged in the plastic pipe in a form-fit manner in the circumferential direction around the pipe longitudinal axis.

An apparatus according to the invention enables the continuous production of a pipe base body for a plastic pipe. The apparatus comprises a known molding section with half-molds and an injection head with an outer nozzle for extruding an outer pipe and with an inner nozzle for extruding an inner pipe with a smooth pipe inner side. A calibration mandrel is arranged at the end of the injection head, which is used to cool and calibrate the inner pipe. For this purpose, the calibration mandrel has a supporting pipe, a cooling jacket held thereon and an outer sleeve held thereon. The essentially cylindrical outer sleeve has at least one molded structure that serves to integrally form the at least one guide element on the smooth pipe inner side. This makes it possible to produce the at least one guide element in a continuous method, in particular by extrusion of the pipe base body. The separating element is subsequently inserted axially into the pipe base body with the at least one guide element.

Further features, advantages and details of the invention will become apparent from the following description of embodiment examples with reference to the drawing.

### BRIEF DESCRIPTION OF THE DRAWING

FIG. 1 shows an apparatus for the continuous production of a pipe base body of a plastic pipe according to the invention,

FIG. 2 shows a longitudinal section of an injection head of the apparatus in FIG. 1,

FIG. 3 shows an enlarged detailed representation in longitudinal section of a cooling mandrel of the injection head according to FIG. 2 with a groove-shaped molded structure,

FIG. 4 shows a sectional representation according to section lines IV-IV in FIG. 3,

FIG. 5 shows an enlarged detailed representation of a molded structure according to detail V in FIG. 4,

FIG. 6 shows a representation, corresponding to FIG. 5, of a modified molded structure according to a further embodiment example,

FIGS. 7 to 9 show representations corresponding to FIGS. 3 to 5 of a cooling mandrel with an elevated molded structure,

FIG. 10 shows a representation of a molded structure corresponding to FIG. 9 according to a further embodiment example,

FIGS. 11 to 13 shows a partially sectioned side view of a plastic pipe according to the invention as a composite pipe with a guide element designed as a web with a cross-profiled separating element,

FIGS. 14 and 15 show further embodiments of plastic pipes with oppositely arranged guide elements and with different types of separating elements,

FIGS. 16 to 18 show representations corresponding to FIGS. 11 to 13 of a composite pipe according to a further embodiment example with a guide element designed as a groove,

FIG. 19 shows a representation, corresponding to FIG. 18, of a plastic pipe according to a further embodiment example with two adjacent guide elements, each designed as a web, and a separating element arranged therebetween.

### DESCRIPTION OF THE PREFERRED EMBODIMENTS

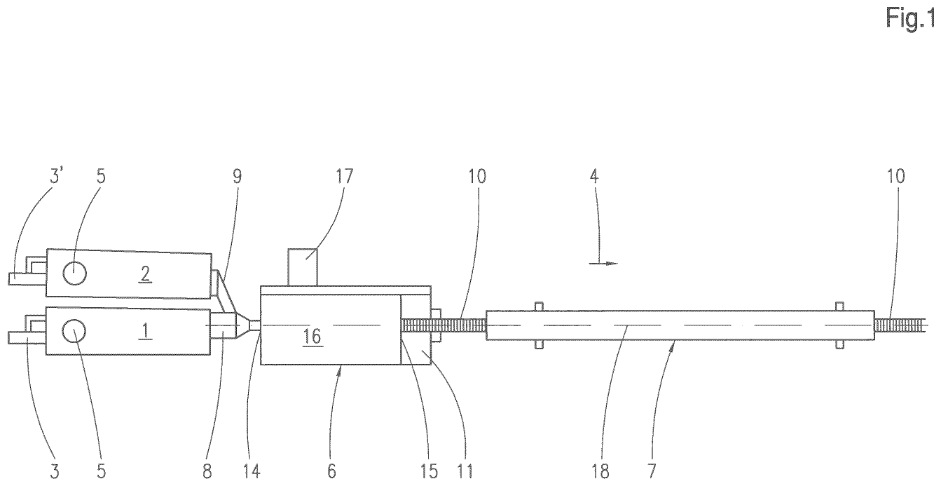

An apparatus shown in FIG. 1 for the production of composite pipes comprises two extruders 1, 2. These are each driven by a variable-speed drive motor 3, 3′, which—in relation to a conveying direction 4 of the entire apparatus—is provided upstream of feed hoppers 5 of the extruders 1, 2.

In relation to the conveying direction 4 downstream of the extruders 1, 2, a molding machine 6, a so-called corrugator, is arranged, which in turn is followed by a post-cooling device 7. A cross injection head 8, which projects into the molding machine 6, is attached to an extruder 1 arranged in alignment with the molding machine 6 and the post-cooling device 7. The other extruder 2, arranged to the side of this extruder 1, is connected to the cross injection head 8 via an injection channel 9 opening laterally into the cross injection head 8. As schematically indicated in FIG. 1, a composite pipe 10 is formed in the molding machine 6, which emerges from the molding machine 6 in the conveying direction 4 and is cooled in the post-cooling device 7. It can then be cut into pieces of a suitable length downstream of this post-cooling device 7. The design of the molding machine 6 is known and is described, for example, in EP 0 563 575 A2, to which express reference is made.

It essentially comprises a machine table 11 on which half-molds 12, 12′ are arranged, each of which are connected to each other to form two so-called chains 13, 13′. These chains 13, 13′ are guided at the upstream inlet end 14—in relation to the conveying direction 4—and at their downstream outlet end 15 via deflection rollers not shown. During circulation in the conveying direction 4, they are guided in such a manner that in each case two half-molds 12, 12′ are combined to form a mold pair, with successive mold pairs lying close together in the conveying direction 4. The drive of the half-molds 12, 12′, which are brought together on a molding section 16 to form mold pairs, is carried out by means of a drive motor 17.

The cross injection head 8 has two melt channels arranged concentrically to a common central longitudinal axis 18, namely an inner melt channel 19 and an outer melt channel 20, which—in relation to the conveying direction 4—end downstream in an inner nozzle 21 and an outer nozzle 22 respectively. The inner melt channel 19 is connected to an injection channel 23 of the extruder 1 arranged in alignment with the molding machine 6, whereas the outer melt channel 20 is connected to the injection channel 9 of the other extruder 2.

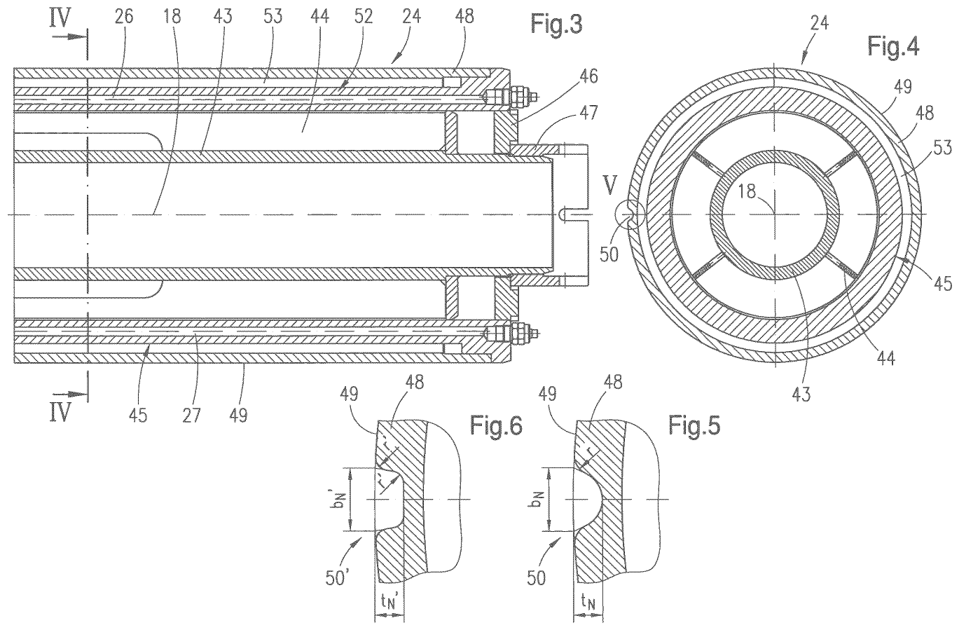

A calibration mandrel 24, which also extends concentrically to the central longitudinal axis 18, is attached to the downstream end of the injection head 8 with respect to the conveying direction 4. It has cooling channels 25 for a cooling medium, in particular cooling water, which is supplied via a cooling water supply line 26 and discharged via a cooling water return line 27. The lines 26, 27 can be guided through an approximately tubular supply channel formed concentrically to the central longitudinal axis 18 in the injection head 8. Alternatively, the lines 26, 27 can also be integrated in the calibration mandrel 24, as shown in FIGS. 3 and 4.

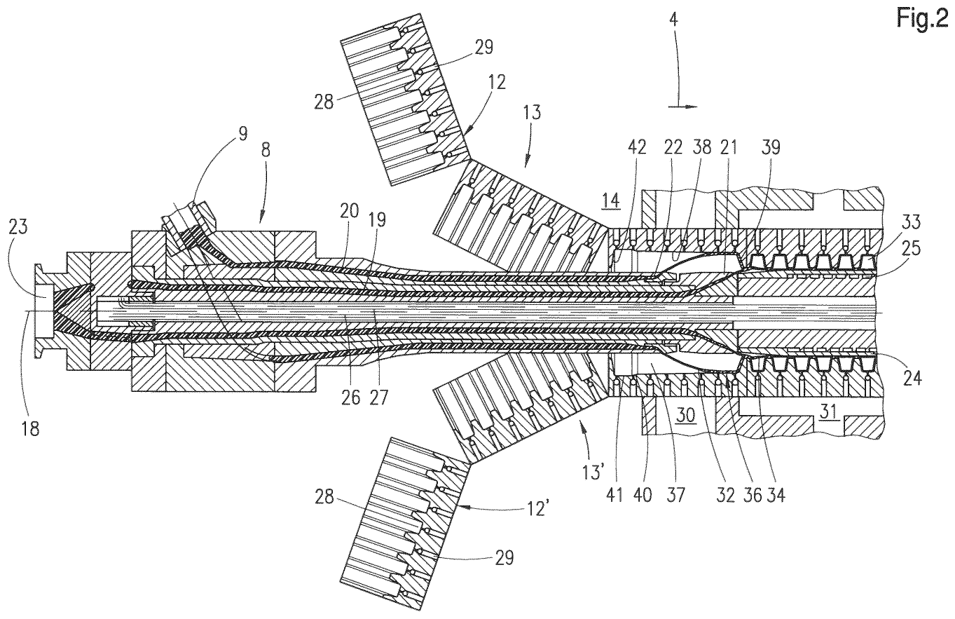

The half-molds 12, 12′ have annular mold recesses 28, which are arranged at regular intervals one behind the other and which are each connected to partial vacuum channels 29. When the half-molds 12, 12′ enter the molding section 16, the partial vacuum channels 29—as can be seen in FIG. 2—reach partial vacuum supply sources 30, 31, so that the mold recesses 28 are subjected to partial vacuum.

The plastic melt fed from the extruder 2 through the injection channel 9 to the injection head 8 flows through the outer melt channel 20 to the outer nozzle 22 and is extruded there, forming an outer pipe 32. Due to the partial vacuum, the outer pipe 32 settles into the mold recesses 28, forming a pipe with transverse corrugations. The transverse corrugations form elevations 33 on the pipe outer side. Plastic melt is fed from the extruder 1 through the injection channel 23 to the cross injection head 8 and flows through the inner melt channel 19 to the inner nozzle 21, where it emerges as the inner pipe 34, which reaches the calibrating mandrel 24. The latter expands slightly outwards from the inner nozzle 21 in the conveying direction 4 until the inner pipe 34 reaches the corrugation troughs 35 of the outer pipe 32 and is welded thereto.

After cooling and solidification, the inner pipe 34 and the outer pipe 32 form a pipe base body of the composite pipe 10.

As can be seen in particular in FIG. 2, the half-molds 12, 12′ are designed such that pipe sockets 36 are formed at predetermined intervals within the endless composite pipe 10. For this purpose, a substantially cylindrical socket recess 37 is formed in a pair of half-molds 12, 12′, which thus has a substantially smooth, cylindrical wall 38.

A transition section 39 is formed between the wall 38 of the socket recess 37 and the mold recess 28, which leads in the conveying direction 4. A frustoconical mold section 40 is connected to the end of the wall 38 of the socket recess 37 that is trailing in the conveying direction 4, in which an outwardly widening insertion end 41 of the socket 36 is formed. This in turn is followed by a transition section 42, which leads to the next mold recess 28, trailing in the conveying direction 4.

Insofar as the apparatus has been described up to this point, it is essentially known from EP 0 995 579 A2, to which express reference is made.

A special design of the calibration mandrel 24 is explained in more detail below with reference to FIGS. 3 to 5. The calibration mandrel 24 is used to cool and calibrate the inner pipe 34 during composite pipe production. The calibrating mandrel is a cooling/calibrating mandrel.

The calibrating mandrel 24 has a supporting pipe 43 oriented concentrically to the central longitudinal axis 18, on the outer side of which a plurality of supporting webs 44 is arranged, four of which are oriented radially with respect to the central longitudinal axis 18 according to the embodiment example shown.

A cooling jacket 45 with a cooling mandrel core 52 is arranged concentrically to the supporting pipe 43, in which cooling mandrel core 52 the cooling water supply line 26 and the cooling water return line 27 are integrated. The cooling jacket 45 is axially secured with respect to the central longitudinal axis 18 on the supporting pipe 43 by means of a retaining disc 46 and an axial sleeve 47. The retaining disc 46 is designed as an annular disc and is attached to the cooling mandrel core 52 at its outer diameter.

The cooling jacket 45 is configured, in particular in the region of its axial end, in particular stepped in such a manner that the outer sleeve 48 is arranged at a radial distance from the cooling mandrel core 52. The cooling jacket 45 comprises the tubular cooling mandrel core 52. The cooling water supply line 26 and the cooling water return line 27 are arranged in the cooling mandrel core 52, in particular diametrically opposite one another with respect to the central longitudinal axis 18. The lines 26, 27 run parallel to the central longitudinal axis 18.

An annular gap 53 is formed between the cooling mandrel core 52 and the outer sleeve 48, which annular gap 53 serves as a cooling section for the calibration mandrel 24.

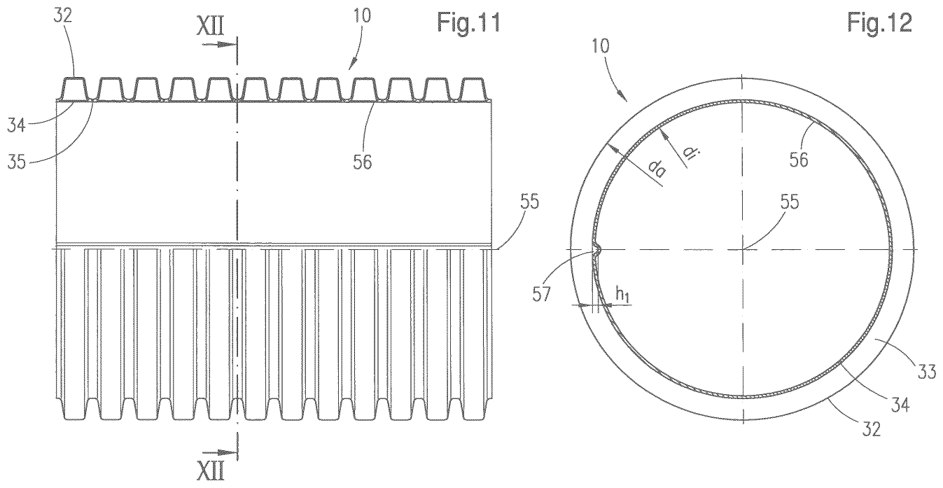

An outer sleeve 48 is arranged on the cooling jacket 45 and held against it. The outer sleeve 48 is configured to be hollow cylindrical and has a mold structure 50 on its outer side 49, which is shown enlarged in FIG. 5. The mold structure 50 is designed as an outer groove on the outer sleeve 48. In the plane oriented as perpendicular to the central longitudinal axis 18, which corresponds to the drawing plane in FIG. 4, the outer groove has a semicircular shape with a groove depth ty and a groove width b_{N}. In the semicircular design, the groove width by is twice as large as the groove depth t_{N}. At the transition to the outer side 49, the groove contour is rounded with a rounding radius r of at least 2.0 mm. When the inner pipe 34 is cooled and calibrated via the calibrating mandrel 24 during the production of the composite pipe 10, a corresponding guide element 57 is formed in the mould structure 50 on the inner pipe 34, which is explained in more detail with reference to FIGS. 11 to 13.

As shown in FIG. 6, the mold structure 50′ can also be designed to be essentially rectangular, with a groove depth t_{N}′ and a groove width b_{N}′. According to the embodiment example shown, the groove width b_{N}′ is approximately twice as large as the groove depth t_{N}′. In particular, the following applies: b_{N}′=1.0×t_{N}′ . . . 3.0×t_{N}′. The groove contour is rounded at the transition to the outer side 49 and in the groove base with rounding radii r′.

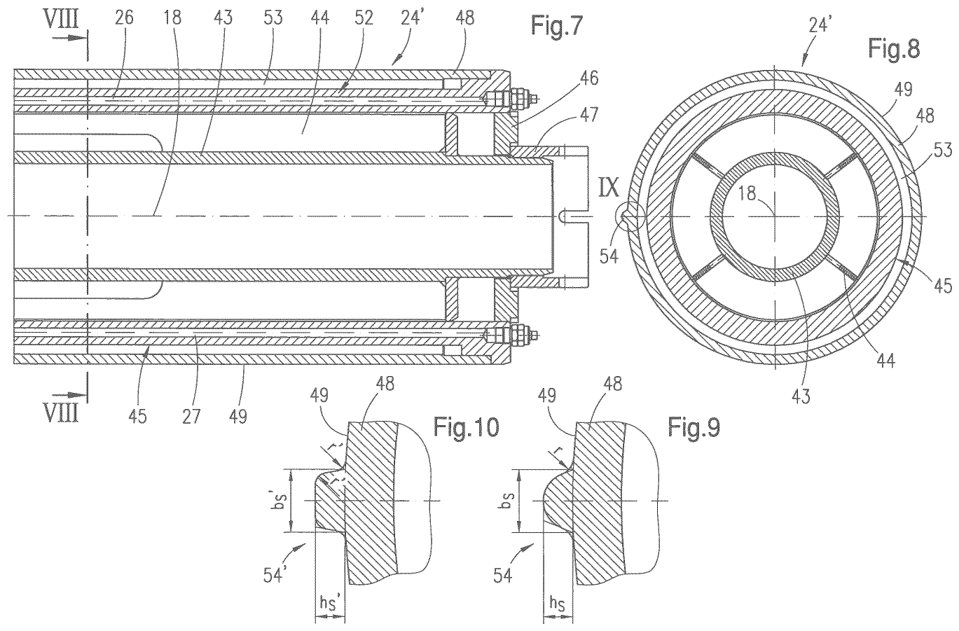

The calibration mandrel 24′ shown in FIGS. 7 to 9 corresponds to the calibration mandrel 24 in terms of its basic structure, reference to which is hereby made.

The only difference in the calibration mandrel 24′ is the design of the mold structure 54, which is formed as a raised web on the outer side 49 of the outer sleeve 48. As shown in FIG. 9, the web can have a semi-circular shape with a web height h_{S} and a web width b_{S}. In the transition region of the web contour to the outer side 49, rounding radii r are present, which are at least 2.0 mm.

As shown in FIG. 10, the web-like mold structure 54′ can be designed to be essentially rectangular with a web height h_{S}′, a web width b_{S}′ and corresponding rounding radii r′. In particular, the following applies: b_{S}′=1.0×h_{S}′ . . . 3.0×h_{S}′.

A pipe base body of the composite pipe 10 produced using the apparatus and the cooling mandrel 24 according to FIGS. 3 to 5 is shown in FIGS. 11 to 13. The composite pipe 10 is a plastic pipe and has a pipe longitudinal axis 55. The inner pipe 34 of the composite pipe 10 is welded to the outer pipe 32 in the region of the corrugation troughs 35. In the outer pipe 32, the transverse grooves are formed as elevations 33 oriented to be perpendicular to the pipe longitudinal axis 55. The outer pipe 32 forms a pipe outer side of the composite pipe 10. The inner pipe 34 is designed to be cylindrical with respect to the pipe longitudinal axis 55 with a smooth pipe inner side 56.

As a result of the groove-shaped mold structure 50 of the calibration mandrel 24, the inner pipe 34 has an integrally formed, i.e. molded-on in one piece, guide element 57. The contour of the guide element 57 corresponds to the contour of the mold structure 50. The guide element 57 extends to be parallel to the pipe longitudinal axis 55. The guide element 57 is oriented axially. The guide element 57 forms a guide web or a guide rail.

The guide element 57 projects into the inner pipe space enclosed by the pipe base body with a first height h₁ which is at least 1.0% of the inner diameter di of the inner pipe 34. In particular, the following applies: h₁≥1.5%×dᵢ, in particular 2.0%×dᵢ and in particular h₁≥2.5%×dᵢ. In particular, h₁=t_{N}.

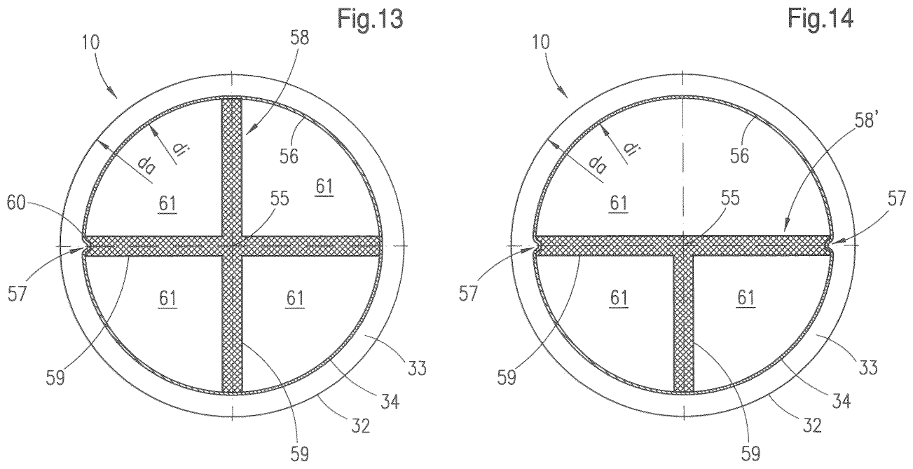

A separating element 58 is held on the guide element 57 in the plastic pipe according to the invention as shown in FIG. 13. The separating element 58 is designed as a cross profile and is arranged concentrically to the pipe longitudinal axis 55. The separating element 58 has two intersecting webs 59, which are connected to each other in a central position and in one piece. The web 59 facing the guide element 57 has an end face contour 60 corresponding to the guide element 57, with which end face contour 60 the separating element 58 can be inserted into the inner pipe 34 and is held on the guide element 57. The separating element 58 is held in the composite pipe 10 so that it cannot twist and is angularly accurate with respect to the pipe longitudinal axis 55. The separating element 58 divides the pipe inner space of the composite pipe 10 into four, in particular equally sized, subchannels 61. The guide element 57 ensures that the separating element 58 is prevented from twisting with respect to the pipe longitudinal axis 55. The three remaining end faces of the webs 59 support the separating element 58 on the pipe inner side 56. The separating element 58 is robustly arranged in the pipe base body. An unintentional change in the rotational position of the separating element 58 is reliably prevented.

According to a further embodiment example as shown in FIG. 14, two guide elements 57 are formed on the inner pipe 34. The guide elements 57 are arranged diametrically opposite one another with respect to the pipe longitudinal axis 55.

The fact that the separating element 58′ is held in the inner pipe 34 by two guide elements 57 increases the freedom of design with regard to the geometry of the separating element 58′. The separating element 58′ can be designed in a T-shape, i.e. it only has three webs 59. This makes it possible to divide the plastic pipe 10 into three, in particular differently sized, subchannels 61.

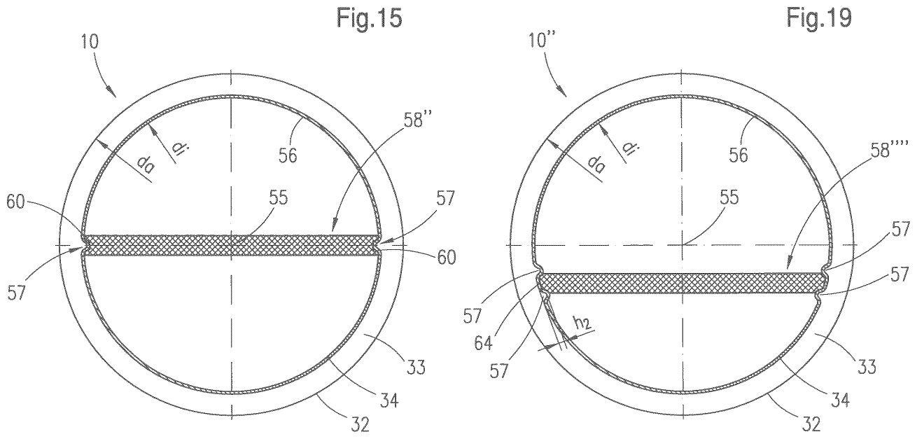

In the embodiment example of the composite pipe 10 shown in FIG. 15, two opposing guide elements 57 are formed, as in FIG. 14. The separating element 58″ is configured to be plate-shaped with corresponding end face contours 60 on both sides. The separating element 58″ is held exclusively on the guide elements 57. Further webs, in particular oriented transversely to the plate plane, for support on the pipe inner side 56 are dispensable.

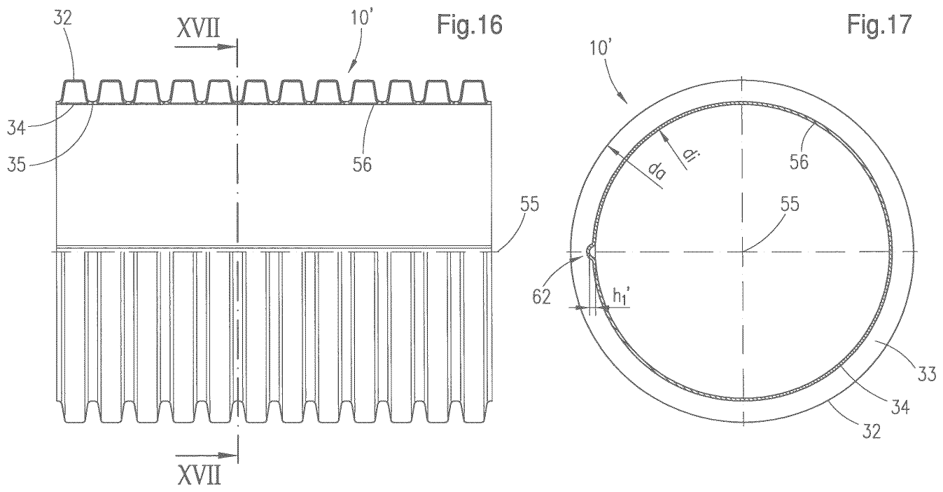

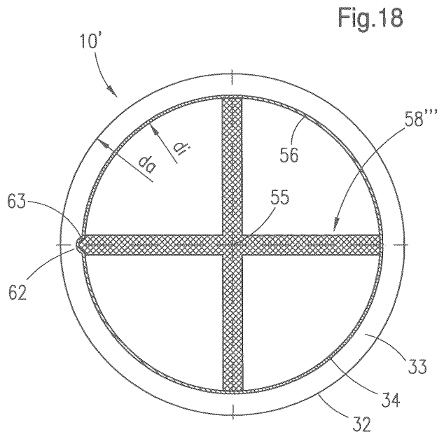

In a further embodiment example of a composite pipe 10′ according to FIGS. 16 to 18, the guide element 62 is designed as a groove corresponding to the mold structure 54 according to FIGS. 7 to 9. The separating element 58″′ is mounted and held analogously. The separating element 58″′ has an end face contour 63 corresponding to the guide element 62, which end face contour 63 is designed as a web-like elevation. It is understood that a plurality of guide elements can also be formed on the pipe inner side 56 of the groove-like guide element 62, in particular diametrically opposite one another.

The first height h₁′ is defined in particular by the web height h_{S} of the mold structure 54.

In the embodiment example of a composite pipe 10″ according to FIG. 19, two guide elements 57 are arranged adjacent to each other with respect to a circumferential direction around the pipe longitudinal axis 55. A guide gap 64 is formed between the two adjacent guide elements 57, in which guide gap 64 the separating element 58″″ is held. This arrangement is particularly robust. In particular, this arrangement enables the separating element 58″″ to be positioned off-center with respect to the pipe longitudinal axis 55.

The adjacent guide elements 57 each have a second height h₂, which can in particular be configured to be smaller than the first height h₁. In particular, the following applies: h₂≥0.5%×dᵢ, in particular h₂≥0.8%×dᵢ, in particular h₂≥1.0%×dᵢ and in particular h₂≥1.5%×dᵢ.

What is claimed is:

1. A plastic pipe comprising
a. elevations oriented to be perpendicular to a pipe longitudinal axis on an outer side of the pipe,
b. a pipe inner side on which at least one guide element oriented to be parallel to the pipe longitudinal axis is integrally formed,
c. a separating element held on the at least one guide element.

2. The plastic pipe according to claim 1, wherein the plastic pipe is designed as a composite pipe comprising an inner pipe having an inner diameter (dᵢ) and an outer pipe which is welded to the inner pipe and has an outer diameter (dₐ), wherein: dₐ/dᵢ≥1.15.

3. The plastic pipe according to claim 1, wherein the at least one guide element is designed as one of a groove and a web.

4. The plastic pipe according to claim 1, wherein the at least one guide element has, in a plane oriented perpendicularly to the pipe longitudinal axis, a contour whose radii (r; r′) are at least 2.0 mm.

5. The plastic pipe according to claim 1, wherein there is exactly one guide element which has a first height (h₁; h₁′) relative to the pipe inner side in the radial direction with respect to the pipe longitudinal axis, wherein one of h₁≥1.0%·dᵢ and h₁′≥1.0%·dᵢ.

6. The plastic pipe according to claim 1, wherein a guide gap, in which the separating element is arranged, is formed between two guide elements arranged adjacently in the circumferential direction about the pipe longitudinal axis.

7. The plastic pipe according to claim 1, wherein there is a plurality of guide elements on which the separating element is held.

8. The plastic pipe according to claim 1, wherein a plurality of guide elements are present, each of which has a second height (h₂) relative to the pipe inner side in the radial direction with respect to the pipe longitudinal axis, wherein h₂≥0.5%·dᵢ.

9. The plastic pipe according to claim 1, wherein the separating element is designed as one of a plate and an open profile.

10. The plastic pipe according to claim 9, wherein the separating element is designed as a cross profile.

11. The plastic pipe according to claim 1, wherein the separating element has an end face contour corresponding to the at least one guide element.

12. An apparatus for the continuous production of a pipe base body for a plastic pipe comprising
a. half-molds which are provided with annular mold recesses and complement each other in pairs on a molding section to form a mold with a central longitudinal axis and which are arranged in a circuit and in a conveying direction,
b. an injection head of at least one extruder arranged upstream of the molding section, wherein the injection head has
i. an outer nozzle for extruding an outer pipe,
ii. an inner nozzle arranged downstream in the conveying direction for extruding an inner pipe,
iii. a calibrating mandrel arranged downstream in the conveying direction with
an inner supporting pipe extending along the central longitudinal axis,
cooling jacket held by the supporting pipe with an integrated cooling channel,
an outer sleeve held on the cooling jacket with at least one molded structure for integrally forming the at least one guide element.
